(19) United States
(12) Patent Application Publication
(10) Pub. No.: US 2026/0225593 A1
(43) Pub. Date: Aug. 6, 2026

(54) METHOD FOR OPERATING AN ADAPTIVE SPEED CONTROLLER

(71) Applicant: Valeo Schalter und Sensoren GmbH, Bietigheim-Bissingen (DE)

(72) Inventors: Ornella Nath, Bietigheim-Bissingen (DE); Philipp Hugger, Bietigheim-Bissingen (DE); Graziano Nardelli, Bietigheim-Bissingen (DE); Ivan Surovtcev, Bietigheim-Bissingen (DE)

(73) Assignee: Valeo Schalter und Sensoren GmbH, Bietigheim-Bissingen (DE)

(21) Appl. No.: 19/153,141

(22) PCT Filed: Jan. 25, 2024
(86) PCT No.: PCT/EP2024/051695

§ 371 Date: Aug. 1, 2025

(30) Foreign Application Priority Data
Feb. 2, 2023 (DE) 10 2023 102 525.2

(51) Int. Cl. B60W 30/16; B60W 50/08

(52) U.S. Cl. CPC B60W 30/16; B60W 30/162; B60W 50/08; B60W 2540/215; B60W 2554/4026; B60W 2554/4041; B60W 2554/4042; B60W 2554/802; B60W 2555/60; B60W 2720/106; B60W 2754/30

(57) ABSTRACT

Described is a method for operating an adaptive speed controller of an ego-vehicle. The method includes selecting a first vehicle travelling ahead as a target vehicle and controlling a distance between the target vehicle and the ego-vehicle. A second vehicle travelling ahead in a lane section in front of the target vehicle is identified, and a speed difference between the second vehicle travelling ahead and the target vehicle is determined. The speed difference is compared with a speed threshold value, and a distance between the second vehicle travelling ahead and the target vehicle is determined. The distance is compared with a distance threshold value, and an acceleration of the ego-vehicle is limited according to the comparisons.

The present invention relates to a method for operating an adaptive speed controller, to a computer program product, to a control apparatus for a vehicle and to a vehicle.

When using an adaptive speed controller, there are situations in which a vehicle traveling ahead (hereinafter also referred to as “first” vehicle), with respect to which the ego vehicle controls a distance and/or depending on which a speed is adjusted, accelerates. The first vehicle traveling ahead can accelerate for several reasons. On the one hand, because a second vehicle traveling ahead of the first vehicle traveling ahead accelerates, on the other hand, because the first vehicle traveling ahead wants to overtake the vehicle traveling ahead and thus increases speed. In the first case, it is intended that the ego vehicle should continue to control the distance from the first vehicle traveling ahead. In the second case, however, it is unfavorable if the ego vehicle accelerates, since it has the vehicle traveling ahead in front of it and must first brake as soon as the first vehicle traveling ahead performs the overtaking process.

US 2019/0315355 A1 discloses an adaptive speed controller for a vehicle that is configured to identify a changing state of a small vehicle. A unit for storing an upper limit is configured to store an upper limit value of a target acceleration that has been set prior to the identification of the changing state of the small vehicle by the determination unit. A target acceleration setting unit is configured to set the target acceleration to a value equal to or lower than the upper limit value, as long as the small vehicle is selected as a following object.

Against this background, it is an object of the present invention to provide an improved method for adaptive speed control.

A first aspect provides a method for operating an adaptive speed controller of an ego vehicle. The method comprises the steps of:
a) selecting a first vehicle traveling ahead as a target vehicle;
b) controlling a distance between the target vehicle and the ego vehicle;
c) identifying a second vehicle traveling ahead on a section of road ahead of the target vehicle;
d) determining a speed difference between the second vehicle traveling ahead and the target vehicle;
e) comparing the speed difference with a speed limit value;
f) determining a distance between the second vehicle traveling ahead and the target vehicle;
g) comparing the distance with a distance limit value; and
h) limiting an acceleration of the ego vehicle depending on the comparisons in steps e) and g).

This method has the advantage that acceleration of a vehicle traveling ahead is only taken over by the ego vehicle if it remains in the lane of the ego vehicle with a high probability. This is indicated by the distance between the first vehicle traveling ahead and the second vehicle traveling ahead, as well as their relative speed. In this way, the adaptive speed controller of the ego vehicle can be prevented from incorrectly accelerating and braking. This results on the one hand in a higher level of application safety for the adaptive speed controller and on the other hand in increased driving comfort for ego vehicle passengers.

The vehicle is, for example, a motor vehicle, such as a passenger car or a heavy goods vehicle.

A first vehicle traveling ahead is selected as the target vehicle if it meets predetermined criteria of the adaptive speed controller. These criteria include, for example, the fact that the target vehicle is a vehicle and not another road user, such as a pedestrian.

“Selecting” the target vehicle is understood as meaning that the vehicle in question is used as the target to which the adaptive speed controller controls. This is done in particular by selecting or setting a value in software of the adaptive speed controller.

The adaptive speed controller of the ego vehicle is configured to control a distance between the target vehicle and the ego vehicle. The distance is controlled in particular by adjusting the speed of the ego vehicle. The adaptive speed controller receives sensor data from one or more ego vehicle sensors, which are used, for example, to determine the speed of the target vehicle and a distance between the target vehicle and the ego vehicle. The adaptive speed controller is further configured to actuate an engine control device, a braking device and/or a steering device of the ego vehicle.

The adaptive speed controller controls the distance between the target vehicle and the ego vehicle by actuating the engine control device, the steering device and/or the braking device of the ego vehicle and thereby induced acceleration or braking.

A second vehicle traveling ahead is identified in step c) in particular by one or more sensors of the ego vehicle. The sensors described here are in particular one or more cameras (for example a front camera) of the ego vehicle. For the purpose of identification, object recognition (for instance by means of software-based image recognition) can be carried out in the image data acquired by the one or more cameras.

The second vehicle traveling ahead is identified when the second vehicle traveling ahead is on a section of road ahead of the target vehicle. In particular, the second vehicle traveling ahead is identified if it is not obscured by the target vehicle.

A speed of the second vehicle traveling ahead and a speed of the target vehicle are determined using the sensor data from the one or more sensors of the ego vehicle. A speed difference between the speeds of the two vehicles is then determined.

In step e), the speed is compared with a speed limit value, where the speed limit value may be both a lower and an upper limit value.

Furthermore, a distance between the second vehicle traveling ahead and the target vehicle is determined using the sensor data.

In step g), the determined distance is compared with a distance limit value, where the distance limit value may be both a lower and an upper limit value.

Depending on the comparisons in steps e) and g), an acceleration of the ego vehicle is limited, whereby the comparisons are used to estimate whether the target vehicle remains in the lane of the ego vehicle or whether the target vehicle wishes to overtake the second vehicle traveling ahead. If the speed difference is greater than the speed limit value and if the distance between the target vehicle and the second vehicle traveling ahead is smaller than the distance limit value, it is assumed with a high degree of probability that the target vehicle wishes to overtake the second vehicle traveling ahead.

“Limiting” the acceleration of the ego vehicle is understood as meaning that the adaptive speed controller still follows the vehicle in question (or else no longer in embodiments), but that the ego vehicle does not accelerate when the target vehicle accelerates. This may also mean that a distance between the ego vehicle and the target vehicle is not controlled. For example, the acceleration of the ego vehicle can be limited to zero, a positive value or a negative value.

According to one embodiment, the speed limit value is set before step e), in particular before step a).

For example, the speed limit value may accordingly be a fixed limit value that is set in software of the adaptive speed controller.

The speed limit value may also only be set before step e), for example by the adaptive speed controller, which uses sensor data to estimate a traffic volume around the ego vehicle and derive a speed limit value therefrom. A limit value is preferably set by a driver of the ego vehicle.

According to one embodiment, the speed limit value has a value between 3 km/h and 10 km/h.

According to one embodiment, the distance limit value is set before step g), in particular before step a).

For example, the distance limit value may accordingly be a fixed limit value that is set in software of the adaptive speed controller.

The distance limit value may also only be set before step e), for example by the adaptive speed controller, which uses sensor data to estimate a traffic volume around the ego vehicle and derive a distance limit value therefrom. A distance limit value is preferably set by a driver of the ego vehicle.

According to one embodiment, the distance limit value has a value between 0 m and 25 m. The distance limit value particularly advantageously has a value of 10 m.

According to one embodiment, in step h), the acceleration of the ego vehicle is limited if the speed difference is greater than the speed limit value and the distance is smaller than the distance limit value.

According to one embodiment, the target vehicle is a motorcycle.

According to one embodiment, the distance between the target vehicle and the ego vehicle is selected depending on the speed of the target vehicle and/or depending on the road conditions.

Accordingly, the distance controlled by the adaptive speed controller in step b) can be determined dynamically depending on the speed of the target vehicle. For example, the adaptive speed controller is configured to never fall below a safety distance, which is half the speed, for example.

Furthermore, the distance between the target vehicle and the ego vehicle can be selected depending on the road conditions. For example, if an ego vehicle sensor detects a wet road, the adaptive speed controller is configured to control a distance that is greater than a distance on a dry road.

According to one embodiment, a driver of the ego vehicle sets the distance between the target vehicle and the ego vehicle before step b) via an input interface.

A driver of the ego vehicle can adjust the distance controlled by the adaptive speed controller itself before step b). The adaptive speed controller is configured, for example, to only allow distances that are greater than a safety distance.

The safety distance is in this case determined by the adaptive speed controller depending on the speed of the ego vehicle. The safety distance is selected here in such a way that, in the event of emergency braking of the target vehicle, the ego vehicle comes to a standstill in time and there is no rear-end collision.

According to one embodiment, steps d) to h) are repeated until the second vehicle traveling ahead is no longer identified.

Accordingly, as long as a second vehicle traveling ahead is identified ahead of the target vehicle, a speed difference and a distance are determined and then the speed difference is compared with the speed limit value and the distance is compared with the distance limit value. This can ensure that the acceleration of the ego vehicle is limited as soon as the speed difference is greater than the speed limit value and the distance is smaller than the distance limit value. This improves a safety aspect of the adaptive speed controller.

According to one embodiment, alternatively or in addition to step h), the target vehicle is retained or deselected depending on the comparisons according to steps e) and g).

“Deselecting” the target vehicle is understood as meaning that the adaptive speed controller no longer controls the vehicle in question or stops following it. To this end, in particular, a value is set in software of the adaptive speed controller. The adaptive speed controller can then select a new target vehicle to follow or may be inactive if, for example, there is no vehicle traveling ahead.

For example, the second vehicle traveling ahead can also be selected as the new target vehicle. This has the advantage that the adaptive speed controller remains active and controls a distance between the second vehicle traveling ahead and the ego vehicle. This prevents the ego vehicle from braking abruptly when the deselected target vehicle leaves the lane for overtaking.

A second aspect provides a method for operating an adaptive speed controller of an ego vehicle, said method comprising the following steps:
a) selecting a first vehicle traveling ahead as a target vehicle;
b) controlling a distance between the target vehicle and the ego vehicle;
c) identifying a second vehicle traveling ahead on a section of road ahead of the target vehicle;
d) determining a speed difference between the second vehicle traveling ahead and the target vehicle;
f) determining a distance between the second vehicle traveling ahead and the target vehicle; and
h) limiting an acceleration of the ego vehicle depending on the determined speed difference and the determined distance.

A third aspect provides a computer program product comprising commands that, when the program is executed by a computer, cause said computer to carry out the method according to the first or second aspect.

A computer program product according to the third aspect may, for example, be provided on a computer-readable storage medium, such as a memory card, USB stick, CD-ROM or DVD. Alternatively, the computer program product can also be provided as a downloadable file from a server on a network. The transmission of the computer program product can be carried out, for example, in a wireless communication network by transmitting a corresponding file with the computer program product.

A fourth aspect provides a control apparatus for a vehicle for operating an adaptive speed controller. The control apparatus comprises: a processor unit and a memory unit on which means for carrying out the method according to the first aspect are stored.

The control apparatus (for example in the form of the central vehicle control apparatus or electronic control unit-“ECU”) is configured in particular to process the computer program product described above for operating an adaptive speed controller, for example on the processor unit of the control apparatus.

The respective unit, for example the memory unit, may be implemented in hardware and/or software. In the case of an implementation in hardware, the respective unit may be in the form of a computer or a microprocessor, for example. In the case of an implementation in software, the respective unit may be in the form of a computer program product, a function, a routine, an algorithm, part of a program code, or an executable object.

A fifth aspect provides a vehicle. The vehicle has: one or more sensors and a control apparatus according to the fourth aspect.

The sensors of the ego vehicle may be, for example, radar sensors, LiDAR sensors, ultrasonic sensors and/or cameras (as already described above). The ego vehicle may have a sensor of one type, multiple sensors of one type and/or multiple sensors of multiple types. The ego vehicle advantageously has multiple sensors of multiple types. The ego vehicle has in particular a radar sensor, which is advantageously arranged in the middle of the front of the ego vehicle.

Steps a), b), c), etc. can also be performed in a different order. The presence of steps a) and c) does not require the presence of an intermediate step b), etc. “A” or “an” does not exclude a plurality.

The features and advantages described here for the first aspect apply mutatis mutandis to the other aspects, and vice versa.

Further possible implementations of the invention also comprise not explicitly mentioned combinations of features or embodiments described above or below with regard to the exemplary embodiments. A person skilled in the art will in this case also add individual aspects as improvements or additions to the respective basic form of the invention.

Further advantageous configurations and aspects of the invention form the subject matter of the dependent claims and of the exemplary embodiments of the invention that are described below. The invention is explained in more detail below on the basis of preferred embodiments with reference to the accompanying figures.

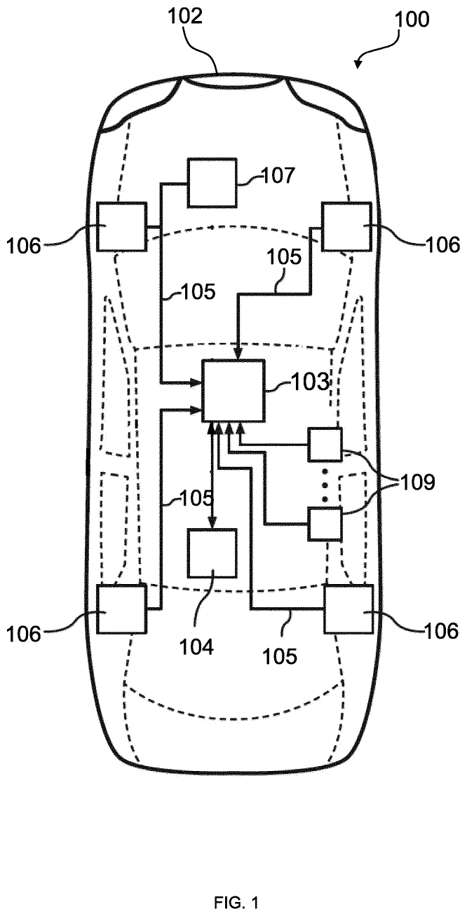

FIG. 1 shows a schematic top view of a vehicle with an adaptive speed controller according to one embodiment;

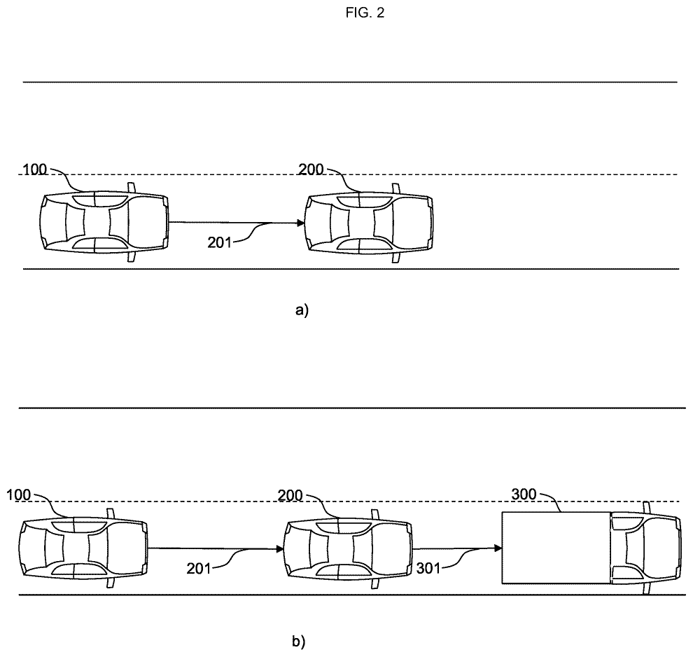

FIG. 2 shows a schematic illustration of a situation in which an adaptive speed controller according to one embodiment is used; and

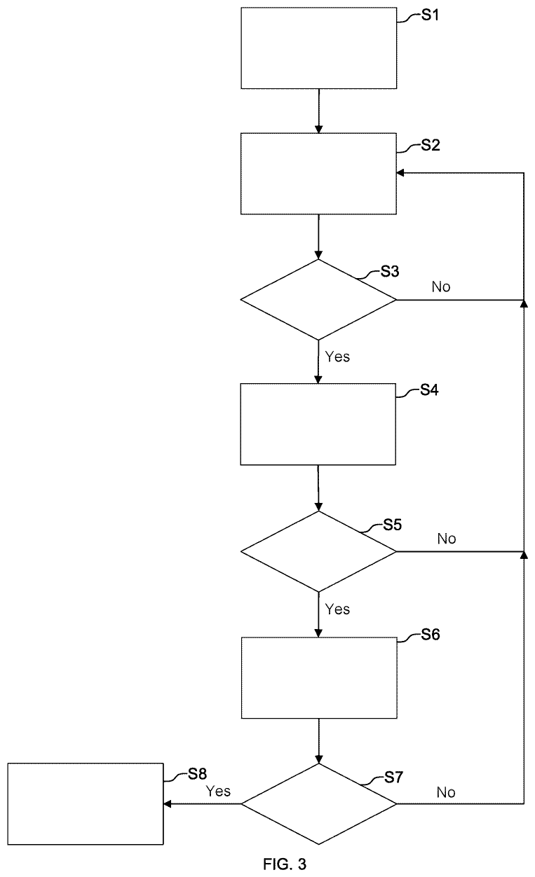

FIG. 3 shows a flowchart of adaptive speed control in accordance with one embodiment. Identical or functionally identical elements are denoted by the same reference signs in the figures, unless stated otherwise.

FIG. 1 shows a schematic top view of a vehicle 100 with a control apparatus 103 and a sensor 102 according to one embodiment. In the example shown in FIG. 1, the vehicle 100 is a motor vehicle, in particular a passenger car. The sensor 102 is designed, for example, as part of a driver assistance system. An adaptive speed controller is designed, for example, as a software component of the driver assistance system. The driver assistance system is used, for example, to assist a driver of the vehicle 100. Furthermore, the driver assistance system may be designed for semi-autonomous or fully autonomous operation of the vehicle 100. The driver assistance system is configured, for example, to control components of the vehicle, such as an engine control device 104, a braking device 106 and a steering device 107, so that driver assistance, semi-autonomous and/or fully autonomous operation can be carried out. For example, the driver assistance system is designed for operation at higher speeds, such as those occurring on a country road or on a motorway, for example. The driver assistance system is also designed for operation at lower speeds, such as those occurring on inner-city roads, for example.

The sensor 102 is in this case a radar sensor and, as illustrated in FIG. 1, is arranged in the middle of the vehicle front of the vehicle 100. The sensor 102 is connected wirelessly and/or in a wired manner to the control apparatus 103 for transmitting sensor data. The vehicle 100 preferably comprises additional sensors 109 configured to detect the driving state of the vehicle 100 and to detect an environment of the vehicle 100. Examples of such sensors 109 of the vehicle 100 are image capture devices, such as a camera, a radar (radio detection and ranging) or a lidar (light detection and ranging), ultrasonic sensors, location sensors, wheel angle sensors and/or wheel speed sensors. The sensors 109 are each configured to provide sensor data, for example to the control apparatus 103 and/or to the driver assistance system, which assists a driver and performs the semi-autonomous and/or fully autonomous driving depending on the detected sensor data.

The control apparatus 103 comprises a processor unit and a memory unit (not illustrated), both configured to carry out the method for operating an adaptive speed controller during the operation of the vehicle 100, described below. The control apparatus 103 is configured to receive sensor data from the sensors 109 of the vehicle, and in particular to receive sensor data from the sensor 102. Data links between the control apparatus 103 and vehicle components are denoted by the reference sign 105, wherein data links represent lines, data lines, a vehicle bus and/or wireless data transmission.

The control apparatus 103 is connected to the engine control device 104 in the exemplary illustration of the vehicle 100 in FIG. 1 and is configured to transmit data to the engine control device 104. The transmitted data contain, for example, control signals that cause the engine control device 104 to accelerate and/or brake the vehicle 100.

The control apparatus 103 in FIG. 1 is also connected to the braking device 106. The control apparatus 103 transmits data wirelessly and/or in a wired manner to the braking device 106 of the vehicle 100, with the data containing, for example, control signals. These control signals cause the braking device 106 to brake the vehicle 100. In particular, the control signals may contain information about a possible impending emergency braking by the driver of the vehicle 100, which is detected by the sensors 109 and/or by the adaptive speed controller, and thus prepare the braking device 106 therefor.

The control apparatus 103 in FIG. 1 is connected to a steering device 107 of the vehicle 100. The control apparatus 103 transmits data wirelessly and/or in a wired manner to the steering device 106 of the vehicle 100, with the data containing, for example, control signals. These control signals cause the steering device 107 to change a steering angle of the vehicle 100. Furthermore, the control apparatus 103 has a computer program product comprising program code means that are stored on a computer-readable medium in order to be able to carry out the method for operating an adaptive speed controller, described below.

A schematic illustration of a situation from FIG. 2, in which an adaptive speed controller according to one embodiment is used, and the flowchart from FIG. 3, are used to explain the method for operating an adaptive speed controller in more detail.

FIG. 2 a) shows the vehicle 100 (subsequently ego vehicle 100) from FIG. 1. A first vehicle 200 traveling ahead is selected as the target vehicle (see step S1 in FIG. 3). In the example illustrated in FIG. 2, the first vehicle 200 traveling ahead is a passenger car. However, the first vehicle 200 traveling ahead may be in particular a motorcycle.

The adaptive speed controller of the ego vehicle 100 is configured to control a distance 201 between the target vehicle 200 and the ego vehicle 100 (see step S2 in FIG. 3). The sensor 102 is used to acquire sensor data and transmit it to the control apparatus 103, which is used to determine the distance 201 and the speed and/or the acceleration of the vehicle 200 traveling ahead. The control apparatus 103 is also configured to control the distance 201 between the target vehicle 200 and the ego vehicle 100. For this purpose, the control apparatus 103 transmits data containing control signals to the engine control device 104, the braking device 106 and/or the steering device 107. These devices then actuate the corresponding vehicle parts so that the distance 201 is controlled.

More precisely, controlling the distance 201 means that the ego vehicle 100 accelerates when the distance 201 is greater than a stipulated distance. Accordingly, the control apparatus 103 transmits data containing control signals to the engine control device 104 so that the engine control device 104 controls the engine of the ego vehicle 100 in order to accelerate the ego vehicle 100. If the distance 201 is smaller than a stipulated distance, the control apparatus 103 transmits data containing control signals to the engine control device 104, to the steering device 107 and/or to the braking device 106 so that the ego vehicle 100 has a negative acceleration.

If the ego vehicle 100 accelerates, the control apparatus 103 for instance ensures that a maximum permissible speed is not exceeded. The maximum permissible speed can be derived, for example, from GPS data of the driver assistance system, where the maximum permissible speed of a route section is specified in a stored map. Furthermore, the maximum permissible speed can also be determined by the sensors 109, which are configured to identify traffic signs.

Furthermore, for example, the driver of the ego vehicle 100 can enter via an input interface a maximum speed that they do not wish to exceed. The control apparatus 103 is furthermore configured to adapt the data transmitted to the engine control device 104 so that the engine control device 104 does not accelerate the ego vehicle 100 to a speed greater than the maximum speed entered by the driver.

The distance 201 between the target vehicle 200 and the ego vehicle 100 is, for example, a distance that is determined by the adaptive speed controller depending on the speed of the target vehicle 200. Accordingly, the distance 201 is determined depending on the speed of the target vehicle 200. The distance 201 is therefore set dynamically and is not a fixed variable. The distance 201 can also be determined according to the road conditions detected by the sensors 109. For example, a distance of 201 is selected to be larger when it is detected that the road is wet than when it is detected that the road is dry.

For example, the distance 201 is a distance determined by the driver of the ego vehicle 100 before step S2. The distance 201 is transmitted, for example, by the driver to the control apparatus 103 by way of an input interface. Accordingly, the adaptive speed controller is configured to control the distance 201 stipulated by the driver of the ego vehicle 100. Furthermore, the adaptive speed controller may be configured to implement only those inputs of the driver of the ego vehicle 100 that are greater than a safety distance. The safety distance is determined by the adaptive speed controller depending on the speed of the ego vehicle 100. The safety distance can be selected here in such a way that the ego vehicle 100 is not involved in a rear-end collision in the event of a vehicle 200, 300 traveling ahead performing an emergency brake, but rather the ego vehicle 100 comes to a stop in time.

In step S3, it is checked whether the ego vehicle 100 detects a second vehicle 300 traveling ahead (here in the example a truck) on a section of road ahead of the target vehicle 200 (step S3 in FIG. 3). If no second vehicle 300 traveling ahead is detected in step S3, the distance 201 from the target vehicle 200 continues to be controlled (step S2 in FIG. 3).

If a second vehicle 300 traveling ahead is detected in step S3, as schematically illustrated in FIG. 2 b), then step S4 in FIG. 3 is carried out.

The ego vehicle 100 identifies the second vehicle 300 traveling ahead, for example by way of the sensor 102 and/or by way of the sensors 109. The second vehicle 300 traveling ahead is identified in particular as soon as a distance between the target vehicle 200 and the second vehicle 300 traveling ahead becomes small, or the second vehicle 300 traveling ahead is a larger vehicle than the target vehicle 200. Furthermore, the second vehicle 300 traveling ahead can be identified when the target vehicle 200 and the second vehicle 300 traveling ahead are driving behind one another with a slight offset, as is often the case on motorways. In step S4, the adaptive speed controller uses sensor data from the sensor 102 to determine the speed of the target vehicle 200 and the speed of the second vehicle 300 traveling ahead. A speed difference between the two specified speeds is then calculated.

In step S5 in FIG. 3, the calculated speed difference is compared with a speed limit value. The speed limit value can be set before step S5, for example by the driver of the ego vehicle 100 via an input interface or in particular before step S1, wherein the speed limit value is stored in the adaptive speed controller. For example, the speed limit value can also be determined dynamically by the adaptive speed controller using the sensor data from the sensors 109 and/or the sensor 102, taking into account a traffic flow or the like. Accordingly, the speed limit value can be determined dynamically. The speed limit value in this case has a value between 3 km/h and 10 km/h. In particular, the speed limit value particularly advantageously has a value of 5 km/h.

If the speed difference is smaller than the speed limit value during the comparison in step S5, the method is carried out from step S2. The adaptive speed controller accordingly further controls the distance 201 between the target vehicle 200 and the ego vehicle 100 (step S2 in FIG. 3). The adaptive speed controller is configured to carry out the method from step S2 and to check accordingly whether a second vehicle 300 traveling ahead is identified (step S3 in FIG. 3).

If the speed difference in the comparison in step S5 is greater than or equal to the limit value, step S6 in FIG. 3 is carried out.

In step S6, the adaptive speed controller uses sensor data from the sensor 102 to determine the distance 301 between the target vehicle 200 and the second vehicle 300 traveling ahead, as illustrated in FIG. 2 b).

In step S7 in FIG. 3, the determined distance 301 is compared with a distance limit value. The distance limit value can be set before step S7, for example by the driver of the ego vehicle 100 via an input interface or in particular before step S1, wherein the distance limit value is stored in the adaptive speed controller. For example, the distance limit value can also be determined dynamically by the adaptive speed controller using the sensor data from the sensors 109 and/or the sensor 102, taking into account a traffic flow or the like. Accordingly, the distance limit value can be determined dynamically. The distance limit value in this case has a value between 0 m and 25 m. In particular, the limit value particularly advantageously has a value of 10 m.

If the determined distance in step S7 is greater than the distance limit value, the adaptive speed controller carries out the method from step S2. Accordingly, the distance 201 between the target vehicle 200 and the ego vehicle 100 is controlled. The adaptive speed controller is configured to carry out the method from step S2 and to check accordingly whether the second vehicle 300 traveling ahead is identified (step S3 in FIG. 3).

In this situation, the driver assistance system or the adaptive speed controller assumes that the target vehicle 200 has increased speed, since the second vehicle 300 traveling ahead has also increased speed. The adaptive speed controller continues to use the target vehicle 200 as a reference for speed or distance control.

If the determined distance 301 in step S7 is smaller than the limit value, as illustrated in FIG. 2 b), the acceleration of the ego vehicle is limited. In addition or alternatively, the target vehicle 200 can be deselected.

In this state, the driver assistance system or the adaptive speed controller assumes that the target vehicle 200 will shortly overtake the second vehicle 300 traveling ahead. For example, the driver assistance system may issue a warning to the driver of the ego vehicle 100 that the adaptive speed controller is not active and/or that the acceleration of the ego vehicle 100 is limited. Furthermore, the adaptive speed controller can select the second vehicle 300 traveling ahead as the new target vehicle.

Steps S4 to S8 are carried out until the second vehicle 300 traveling ahead is no longer detected in step S3. For example, the second vehicle 300 traveling ahead can no longer be detected in particular if the target vehicle 200 is at least as large as the second vehicle 300 traveling ahead. In this case it may be, for example, that the second vehicle 300 traveling ahead is therefore identified only because the target vehicle 200 is traveling behind it in a manner offset to the right or left. If the target vehicle 200 drives behind the second vehicle 300 traveling ahead again, the second vehicle 300 traveling ahead can no longer be identified by the sensors 102, 109 of the ego vehicle 100. In other words, the second vehicle 300 traveling ahead can be obscured by the target vehicle 200. It is thus not possible to determine either a speed difference (step S4) between the speed of the second vehicle 300 traveling ahead and the speed of the target vehicle 200, or a distance (step S6) between the two vehicles.

The speed difference (step S4) and the distance (step S6) can be determined in particular in parallel or in the reverse order. Furthermore, the comparisons (step S5, step S7) can also be performed in parallel or in the reverse order. In another variant, the comparisons or one of the two comparisons according to steps S5 and S7 can be omitted.

Although the present invention has been described on the basis of exemplary embodiments, it is modifiable in a variety of ways.

### LIST OF REFERENCE SIGNS

100 (Ego) vehicle
102 Sensor
104 Engine control device
105 Data link
106 Braking device
107 Steering device
109 Sensors
200 First vehicle traveling ahead
201 Distance (between the ego vehicle and the first vehicle traveling ahead)
300 Second vehicle traveling ahead
301 Distance (between the target vehicle and the second vehicle traveling ahead)
S1 to S8 Method steps

1. A method for operating an adaptive speed controller of an ego vehicle comprising the steps of:
a) selecting a first vehicle traveling ahead as a target vehicle;
b) controlling a distance between the target vehicle and the ego vehicle;
c) identifying a second vehicle traveling ahead on a section of road ahead of the target vehicle;
d) determining a speed difference between the speed of the second vehicle traveling ahead and the speed of the target vehicle
e) comparing the speed difference with a speed limit value;
f) determining a distance between the second vehicle traveling ahead and the target vehicle
g) comparing the distance with a distance limit value; and
h) limiting an acceleration of the ego vehicle depending on the comparisons in steps e) and g).

2. The method as claimed in claim 1, wherein the speed limit value is set before step e).

3. The method as claimed in claim 1, wherein the speed limit value has value between 3 km/h and 10 km/h.

4. The method as claimed in claim 1, wherein the distance limit value is set before step g).

5. The method as claimed in claim 1, wherein the distance limit value has a value between 0 m and 25 m.

6. The method as claimed in claim 1, wherein, in step h), the acceleration of the ego vehicle is limited when the speed difference is greater than the speed limit value and the distance is smaller than the distance limit value.

7. The method as claimed in claim 1, wherein the target vehicle is a motorcycle.

8. The method as claimed in claim 1, wherein the distance between the target vehicle and the ego vehicle is selected depending on the speed of the target vehicle and/or depending on road conditions.

9. The method as claimed in claim 1, wherein a driver of the ego vehicle sets the distance between the target vehicle and the ego vehicle before step b) via an input interface.

10. The method as claimed in claim 1, wherein steps d) to h) are repeated until the second vehicle traveling ahead is no longer identified.

11. A computer program product comprising commands that, when the program is executed by a computer, cause the computer to carry out the method as claimed in claim 1.

12. A control apparatus for a vehicle for operating an adaptive speed controller comprising:
a processor unit; and
a memory unit on which means for carrying out the method as claimed in claim 1 is stored.

13. A vehicle having:
one or more sensors; and
a control apparatus as claimed in claim 12.
